(19) United States
(12) Patent Application Publication
(10) Pub. No.: US 2011/0239781 A1
(43) Pub. Date: Oct. 6, 2011

(54) Open Channel Meter for Measuring Velocity

(76) Inventor: Alan Petroff, Huntsville, AL (US)

(21) Appl. No.: 13/072,752

(22) Filed: Mar. 27, 2011

Related U.S. Application Data
(60) Provisional application No. 61/319,847, filed on Mar. 31, 2010.

(51) Int. Cl. G01F 1/66

(52) U.S. Cl. 73/861.28

(57) ABSTRACT

A system for measuring flow parameters in a drain pipe which may be partially or completely filled. The system comprises wide band pulsed ultrasonic echo ranging sensor disposed in a lower portion of a pipe with a beam directed generally upward at a predetermined inclined angle. Echo information may be processed to determine contiguous particle traces from the same respective particles in a range vs. time format. Particle velocity may be determined based on trace slope or arc. Average particle velocity from a measurement subset of flow may be used to determine a subset average flow rate, which is then related to total flow rate and total flow average velocity based on one or more models. One embodiment may reflect the beam from the surface of the water to extend coverage near the bottom of the pipe and may avoid an exclusion zone at the bottom of the pipe.

### RELATED APPLICATIONS

This application is an application claiming the benefit under 35 USC 119(e) of prior U.S. Provisional Application 61/319,847, titled “Open Channel Meter for Measuring Velocity”, filed Mar. 31, 2010 by Petroff, which is hereby incorporated herein by reference in its entirety.

### BACKGROUND

1. Field of the Invention

The present invention pertains generally to the field of measurement of water flowing in partially and completely full pipes using a sensor that is in contact with the flow, more particularly, to the class of devices that utilize ultrasonic energy to determine the flow channel velocity.

2. Background of the Invention

Accurate measurement of open channel flow in municipal wastewater is needed to size treatment facilities, measure the response of the system to rain events, predict response to future rain events, design improvements to collection systems, plan for system growth, localize inflow/infiltration and apportion the cost of system management among client municipalities.

There are a number of open channel flow meters that attempt to measure these flows using a variety of techniques.

The first class of flow meters relies on primary devices that require either a) the construction of flumes, weirs or other structures in the manhole or b) the installation and proper alignment of these structures in the manhole and monitoring of flows through the structure, such as for example, pressure sensors, floats or other sensors. While this may be a reasonable approach to consider for sewage treatment plants where existing piping systems and structures can be designed and built around the needs of the primary device, it is typically impractical, expensive or simply not possible to properly install such structures in the sewer collection system where the monitoring point of interest is normally deep underground.

Another class of flow meters attempt to measure the average velocity of flow, and then by knowing the pipe geometry and depth of flow, calculate a flow rate. All of these technologies use a number of different but fundamentally common means to measure depth. The key distinction of interest is the measurement of velocity.

The next class of meters utilizes an underwater continuous wave Doppler velocity sensor. Examples of this class include Petroff U.S. Pat. No. 5,020,374, Petroff U.S. Pat. No. 5,333,508, Nabity et al, U.S. Pat. No. 5,371,686, Heckman U.S. Pat. No. 5,421,211, Byrd U.S. Pat. No. 5,821,427, and Petroff U.S. Pat. No. 7,672,797. While generally useful, such devices have issues in that continuous wave Doppler sensors do not read an average velocity. Instead they perform processing, such as for example an FFT, on the return signal and by judging the shape or key features of the return spectra estimate the velocity. The nature of the flow can vary considerably with the depth of the flow and the return can vary as the particle content in the flow changes through the day. While the technique will produce useful results, the accuracy of the readings may not be particularly robust.

Another class of velocity meters is the velocity profiler. Examples include Brumley U.S. Pat. No. 5,208,785 and, Jiwani “Methods of Flow Measurement”, Section 3.2.6. Both systems provide a measure of velocity as a function of distance along the ultrasonic beam. This measurement is called a velocity profile. The final class of devices utilizes a downward looking ultrasonic or radar sensor and the Doppler principle to measure the surface velocity of water flow. Examples of these devices include Bailey U.S. Pat. No. 5,315,880, Marsh U.S. Pat. No. 5,684,250, and Marsh U.S. Pat. No. 5,811,688. While such systems have the advantage of being non-contact techniques they have three limitations. First, the signal returned from the water surface is very weak and is generally undetectable when the water velocity drops below approximately 1 ft/sec. This is a critical limitation because many pipes flow at or below this limit. Second, the precise surface velocity is frequently difficult to distinguish. The signal beam is relatively wide and signals can return from a continuum of locations from the edges of the pipe to many feet upstream. In practice, the downward sensors read a continuum of velocities from the edges of the pipe to many feet upstream. This results in a situation where signal from one part of the water should be compensated by the cosine of 60 degrees whereas other signals may need to be compensated by the cosine of 10 degrees. This conundrum is most difficult for the threshold algorithm to resolve thus decreasing the robustness of system operation. Third, once the surface velocity is measured, average velocity is yet to be determined.

Accordingly, there is an ongoing need for a low cost flow meter that accurately measures average velocity.

### BRIEF DESCRIPTION OF THE INVENTION

The present invention relates to a system for measuring flow parameters in a pipe which may be partially or completely filled with fluid. Flow parameters may include but are not limited to flow velocity, flow volume, depth of flow and surcharge pressure.

Flow velocity may be measured using a narrow beam pulsed ultrasonic sensor whose pulsed transmissions are reflected off of particles in the flow and the received echoes are processed and converted into a measure of the average flow velocity. Depth of flow may be measured by one or more additional sensors.

Flow velocity is determined as a function of a slant range depth within a cone of sensitivity of an ultrasonic sensor. (Slant range is a term borrowed from radar for a range along an inclined beam. Slant angle is the incline angle of the beam.) The flow velocity information is compared with a flow profile model specifically tailored to the installation geometry for determination of flow rate and average velocity information. In one embodiment, the model is based on a computer simulation. Empirically derived models may be used.

In one embodiment, the ultrasonic sensor uses a pulsed transmission wherein each pulse is spread in bandwidth. The receiver uses pulse compression techniques to determine a round trip delay and thus a distance to much finer resolution than the length of the pulse. In one embodiment, the pulse compression is based on an FM chirp process.

In one embodiment, the pulse echo returns are processed using a pulse stacking process wherein multiple consecutive pulse returns are placed in a two dimensional array. Path features are then identified and isolated in the two dimensional array. A slope characteristic is determined for valid path features. In one embodiment, a region of interest referred to as a trace surface patch is determined based on peak values and a trace is developed based on contiguous cells above a threshold. The trace is compared to multiple slope values to produce a slope spectrum function for the region of interest. The slope spectrum function is then processed to determine a velocity estimate. The velocity estimate may be based on a peak of the slope spectrum or on a mean value. Multiple traces are evaluated within the ultrasonic sampling volume to develop measured velocity information associated with depth information for comparison with flow model information to determine an average flow velocity related to volumetric flow.

In one embodiment, a subset measurement region of the flow may be used to develop a mean velocity for the region. The mean velocity for the region is then used to determine an average flow for the total flow cross section based on comparison with flow models or based on laboratory measurements. The system may be typically installed in conjunction with a manhole. A compact sensor head is installed at the bottom of the flow, within the upstream interior of an influent pipe. The sensor is positioned upstream of the pipe exit draw down effects and directed towards the approaching upstream flow. The system typically includes a separate electronics package remotely located out of the flow volume to minimize disturbance of the flow and to provide easy access for maintenance. The electronics package periodically takes both a depth reading from one of the depth sensors and a velocity reading using the ultrasonic sensor. The depth and velocity readings are then stored in memory for immediate use or for later transfer to a base station. The electronics package is also capable of converting the depth and velocity measurements into a flow rate measurement.

The present invention relates to measuring the velocity of water using pulsed ultrasonic transmissions. Pulses are launched into the water at a periodic rate and the time of returning echoes is measured. Since the return signal is coming from a particle in the beam and the beam has a narrow beam width, it is possible to determine the location of each particle in the flow. By performing the same process for subsequent pulses, it is possible to trace individual particles as they move through the beam. This allows the tracking of particle position (combined depth and lateral position) in flow as a function of time. An observed slope of the particle path as a function of distance from the sensor over time may then be processed to determine the apparent velocity of the particle and thus, the flow velocity. By compensating for the elevation angle of the beam relative to the flow (typically 45 degrees) one can convert the apparent particle velocity into an actual particle flow velocity. By observing the slant range of the track of a particle over time and assuming horizontal flow, one can estimate that the center of the track represents the center of the beam and one can thus compute the height of the particle above the bottom of the pipe based on the known beam angle. With further knowledge of the water surface or flow depth from an additional sensor, particle depth from the surface can be calculated.

The angle of the beam should be low enough (near horizontal) so that the ultrasonic slant range measurement from echo delay has a significant sensitivity to the flow vector and should be high enough (near vertical) so that the slant range measurement has a significant depth measurement sensitivity.

Most slant angles can be made to work, but angles between 20 and 60 degrees give good response, preferably between 30 and 50 degrees, more preferably 45 degrees. In one embodiment, it may be desirable to use lower angles, for example 30 degrees, for shallow flows of, for example 10 to 30 centimeters depth, and use higher angles, for example 45 degrees, for deeper flows of for example, one or two meters depth. By repeating this process for many particles over time it is possible to generate a great many estimates of particle velocities such that the velocity at any particular depth of flow can be computed.

With respect to the beam width, the beam should be wide enough to allow sampling a particle position at least twice, preferably at least four times at the highest flow rate to be measured. Preferably, the beam should be sufficiently narrow so that particle tracks do not have significant curvature. Alternatively, additional processing may be applied to accommodate the curvature. Using a transmit beam width of between +/−2 and +/−10 degrees from center at the −3 dB points gives good results. Preferably, the transmit and receive beam have the same width, thus the response of the system would be −6 dB at the beam width angle.

With respect to the pulse repetition rate, the pulse repetition rate should be high enough to observe multiple reflections from particles in the fastest expected flow rate but low enough that echoes from prior pulses do not interfere with the measurements from the most recent transmitted pulse. This is satisfied by using a preferred pulse repetition rate no greater than 200 Hz for deep water applications (pipes 4 feet (1.2 meters) in diameter) and preferably no greater than 2000 Hz for shallow water applications (pipes 6 inches (15 centimeters) in diameter). In one embodiment, the pulse repetition rate may be varied based on a depth sensor reading.

With respect to the pulse waveform, the present invention utilizes a pulse of sufficient bandwidth to provide adequate particle distance resolution to detect particle motion and to distinguish particles. One exemplary embodiment utilizes a continuous wave pulse comprising a plurality of cycles of substantially the same amplitude that are frequency modulated to widen the bandwidth of the pulse. The reception process utilizes match filtering using a pattern that matches the transmitted pulse to provide pulse compression processing to yield particle response resolution finer than the length of the pulse. For example, the transmitted pulse may comprise an FM chirp having a center frequency of approximately 1 MHz, a frequency span of approximately 200 kHz and a time duration between 50 ms and 100 ms. The receiver utilizes a match filter using the same FM chirp pattern to detect responses in the received signal.

Once the received signal is match filtered to produce a filtered response signal, the filtered response signals from multiple pulses are combined and processed to identify candidate continuous tracks representing particle tracks. The candidate tracks are processed to eliminate groups failing to meet qualifying criteria. In one embodiment, the criteria comprise matching a slope of the track to a family of slope hypotheses (alternatively referred to as candidate slopes). Traces not matching the criteria are rejected.

One aspect of one or more embodiments and optional features of the invention is to provide techniques for increasing the accuracy of a flow measurement system by providing refinements and error correction techniques with an objective of reducing error to less than 5%.

The techniques for qualification of valid traces may include, but are not limited to: eliminating traces with multiple peaks; eliminating traces with excessively wide peaks; eliminating traces with strong peaks distant from the main peak; and eliminating traces with too few response cells.

A slope spectrum is then produced and metrics representative of the trace response are produced. Valid traces will produce a narrow and well defined response indicative of its velocity. As a result of this process, the particle depth and velocity of the particles can be determined.

As the process is continued over a period of time, a record of valid traces with associated velocity and depth is accumulated. Thus, the flow is potentially sampled along the full length of the beam from the transducer source to the surface of the water. This record forms basic velocity profile information that can then be used to determine an average flow rate and total flow through the pipe.

The flow profile information can then be used to determine flow over the entire cross section of the flow and thus, the total flow, by comparing the measured data with one or more models of flow behavior. Several exemplary models include but are not limited to: 1) a direct approach wherein an average particle velocity may be determined within at least one flow measurement region defined by a proximal range limit and a distal range limit along the path of the ultrasonic beam, and the average particle velocity may be related to the average flow velocity; 2) a finite element model which can be used to predict expected theoretical velocities along the beam as well in the entire cross-sectional area and thus allows a method for determining the ratio of profile velocity measurements to flow velocity; and/or 3) a measurement approach for flow regimes where the measurement and/or modeling approach becomes difficult (primarily low flow in small pipes), empirical calibration based on lab tests conducted with a reference flow meter, for example a magnetic flow meter reference.

In a further embodiment, for those cases where the sensor cannot be installed directly on the pipe bottom, an adjustment is made that compensates for this installation rotation angle. The adjustment is informed by the analysis of the finite element model results.

The depth of flow can be measured with any of a variety of technologies (pressure sensor mounted in the flow, a mechanical float, downward looking ultrasonic ranger installed at the top of the pipe, an upward looking ultrasonic installed in the flow, capacitance meter, etc). The depth and velocity sensors are typically installed in the influent pipe using a ring and crank assembly.

With knowledge of the pipe geometry, the depth of flow, and the velocity measurements at one or more regions with in the beam, the flow model may be used to determine relationship of the measurements taken to the average flow rate over the entire cross section of the flow. The total flow may then be determined by multiplying the average velocity by the depth determined cross-sectional area of flow.

Further embodiments may include velocity measurements wherein the received signal comprises reflections from a distance corresponding to a reflection from the surface of the water.

In a further embodiment, the measurement region may be bounded by a distance along the beam including a reflection from a surface of the water and extending downward from the reflection to and not beyond a predetermined distance from a bottom of the pipe.

In a further embodiment, the beam is directed to reflect from the surface of the water to extend the measurement region below a blind range of the sensor and to avoid an exclusion zone above the bottom of the pipe.

In a further embodiment, the ultrasonic beam reflects from a surface of the water and the measurement region is bounded by an echo return delay corresponding to an echo range distance of not more than twice the distance from the transducer or transducer mounting surface to the surface of the water along the direction of the ultrasonic beam.

In a further embodiment, the measurement region is further bounded by a predefined distance from a bottom of the pipe to exclude reflections from a flow region near the bottom of the pipe within the predefined distance.

These and further benefits and features of the present invention are herein described in detail with reference to exemplary embodiments in accordance with the invention.

### BRIEF DESCRIPTION OF THE FIGURES

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 is an exemplary drawing of a typical installation of a flow measuring device in accordance with the present invention.

FIG. 2A and FIG. 2B illustrate an exemplary optional surface level sensor head and under water sensor head mounted on an exemplary ring/crank assembly mounted on a ring installed in a pipe.

FIG. 3 is an exemplary profile drawing of a typical sensor installation showing the sensor installation point, the sensor field of view and the water flow depth profile as a function of location in the influent pipe, manhole invert and exit pipe.

FIG. 4 is a block diagram of an exemplary sensor system illustrating the electronic aspects of the invention.

FIG. 5 is a diagram depicting an exemplary transmit signal waveform.

FIGS. 6A and 6B are plots of an exemplary transmit waveform in both the time and frequency domains.

FIG. 6C illustrates an exemplary FM pulse waveform.

FIG. 6D illustrates a replica correlation response of waveform FIG. 6C.

FIG. 7A, through FIG. 7H illustrate the interaction between the transmit waveform and targets in the flow as a function of time.

FIG. 8 is a representative plot of an exemplary Pulse Stack.

FIG. 9 is a functional flow diagram of one exemplary embodiment of the signal processing chain of events.

FIG. 10A FIG. 10B, and FIG. 10C show exemplary trace surface patch plots and associated slope spectra.

FIG. 11A and FIG. 11B are examples of Raw Point Readings plots.

FIG. 12A is an example of the lines of constant velocity as computed from a finite element model.

FIG. 12B illustrates an alternative embodiment wherein the transducer is mounted laterally from the center bottom of the pipe 101.

FIG. 13 illustrates exemplary flow measurement in a 54 inch (137 cm) diameter pipe.

FIG. 14 is a diagram illustrating how the invention may be incorporated into a system to provide flow measurements as part of an instrument installed in a drain pipe.

FIG. 15 illustrates a side view of a measurement volume including a volume covered by reflecting the ultrasonic beam by the surface of the water.

FIG. 16A and FIG. 16B illustrate an exemplary measurement volume associated with reflecting the ultrasonic beam off of the surface of the flow in accordance with FIG. 15.

### DETAILED DESCRIPTION OF THE INVENTION

The present invention is particularly well adapted for measuring flows in sewers and other drain systems, wherein the drain pipes may be either partially or totally full. The sensor assembly is adapted to measure steady state flow in the pipe, without disturbing the flow, and is preferably positioned upstream from the opening of the pipe, away from flow disturbances caused by the pipe opening into a larger space, such as a manhole work space.

In one embodiment, the present invention utilizes acoustic ultrasonic narrow beam sensors mounted at or near the bottom of the pipe to ensonify the flow with a train of frequency modulated pulses. The system then captures the backscatter response from the particles flowing in the water. The backscatter response is then processed with a matched filter and analyzed such that the position and velocity of particles in the flow is determined. The velocity of the particles observed in a portion of the flow is then converted into a measure of average velocity of the total flow (distance/time) and/or total flow rate (volume/time) by reference to factors derived from flow models of the entire flow cross section or factors derived from calibrated experiment. One such conversion process uses direct conversion factors. Another is based on a finite element model.

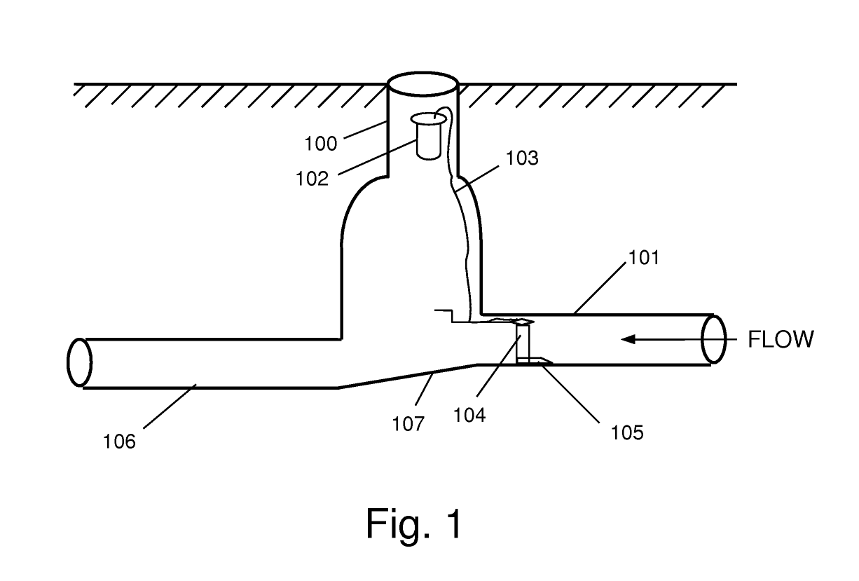

FIG. 1 is an exemplary drawing of a typical installation of a flow measuring device in accordance with the present invention. Turning, now, specifically to FIG. 1, a transmitting and receiving ultrasonic sensor 105 is mounted on an expandable scissors jack mounting ring 104 and is installed in the influent pipe 101 of manhole 100. The scissors jack mounting, as described in Petroff U.S. Pat. No. 4,116,061, is ideal for installation in smaller diameter pipes. U.S. Pat. No. 4,116,061, titled “Sewer Line Analyzer Probe,” issued Sep. 26, 1978 to Petroff is hereby incorporated herein by reference. In the arrangement of FIG. 1, the sensor is preferably positioned at the bottom of the pipe approximately 1 foot or 1 pipe diameter upstream of the pipe termination at the entrance to the manhole such that the sensor is “looking” up stream. In larger diameter pipes, the ring may not be practical. In such cases, the sensor could be mounted on a band of aluminum or stainless steel and fastened to the wall using anchor bolts. If the sensor is not mounted on the pipe bottom but rotated up the side of the pipe, then its location should be noted so that this rotation can be factored into the conversion of the particle velocity information into a total flow measurement. While the sensor could be installed either in the influent pipe 101 or the effluent pipe 106 or even in the manhole invert 107, the hydraulic flow conditions in the influent pipe are typically preferred because of the greater likelihood of well developed stable flow conditions. Sensor 105 is connected through cable 103 to a water proof signal processor/data logger 102 that contains the signal processing, data logging, communications electronics, power supplies and batteries.

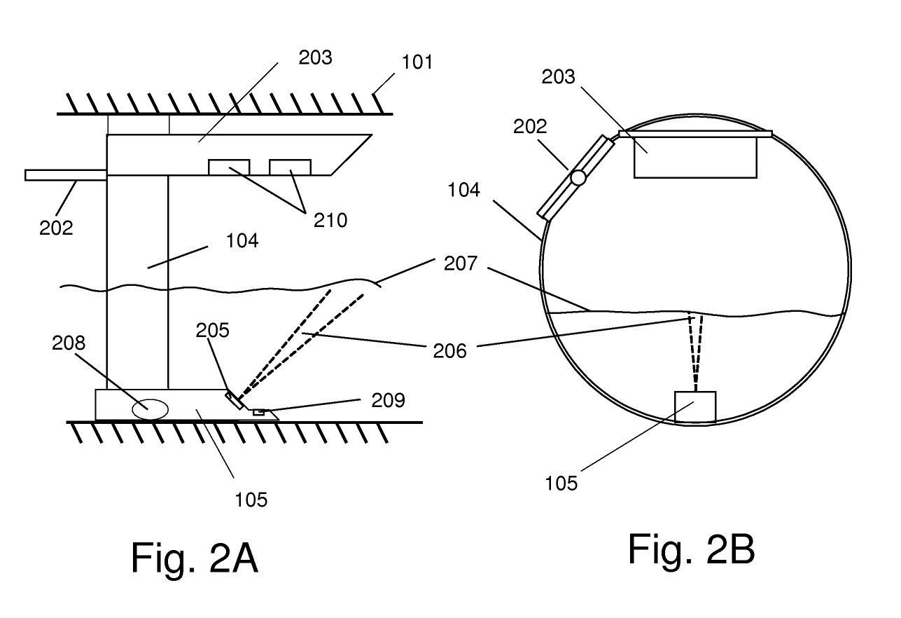

FIG. 2A and FIG. 2B illustrate an exemplary optional surface level sensor head 203 and under water sensor head 105 mounted on an exemplary ring/crank assembly 202 mounted on ring 104 installed in pipe 101. Surface level sensor head 203 contains ultrasonic range sensors 210 for measuring distance by echo ranging to the surface of the water 207, for later computation of the depth of flow. Submerged sensor housing 105 contains ultrasonic velocity sensor pair 205 (alternatively referred to as a transducer), upward looking ultrasonic depth sensor 209 (echo ranging to the surface of the water), and pressure sensor 208 for measuring depth by measuring pressure. Area 206 between the dotted lines indicates a field of view (alternatively referred to as a beam) of the velocity sensor 205. Optional depth/range sensor 209 and optional pressure sensor 208 provide alternate and/or backup depth measurement. Depending on the particular requirements for measuring depth, it may not be necessary to use all of the depth measurement options. Any one of the options may be sufficient.

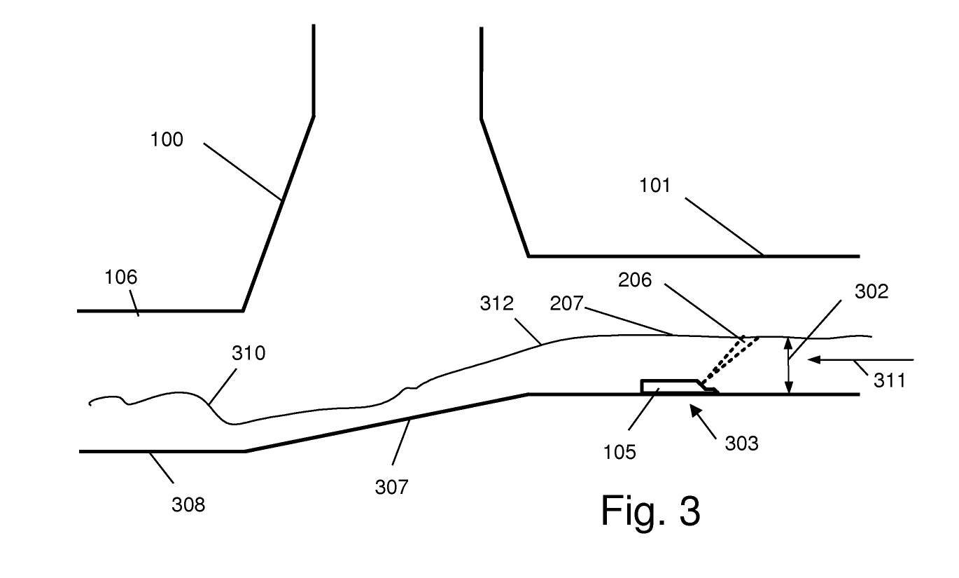

FIG. 3 illustrates an exemplary installed location of sensor head 105 in the influent pipe 101 of manhole 100 as well as the field of view 206 of the velocity sensor 105 relative to the depth of flow 302 in pipe 101. Note that the water surface drops as it enters manhole 100, reaches a minimum in the middle 307 of the manhole, and then experiences a hydraulic jump 310 as it exits manhole 100 and enters effluent pipe 106. FIG. 3 illustrates the benefits of the preferred installation location 303. In principle, sensor 105 can be installed as shown (position 303) or in position 307 or position 308. However, there are practical difficulties that need to be considered. First, the geometry of the pipe at position 307 is seldom fixed and can be quite irregular. Consequently, it is difficult to convert a depth of flow measurement into an estimate of the area of the cross-section of water. Since flow quantity is a function of the average velocity times the cross-section of water, this will result in substantial inaccuracies. Second, the relationship between the velocity profile and the average velocity assumes that the flow is stable for several pipe diameters up stream. Since flow is accelerating at point 307 and decelerating at 308, it will be problematic to accurately convert a velocity profile measurement into an estimate of average velocity.

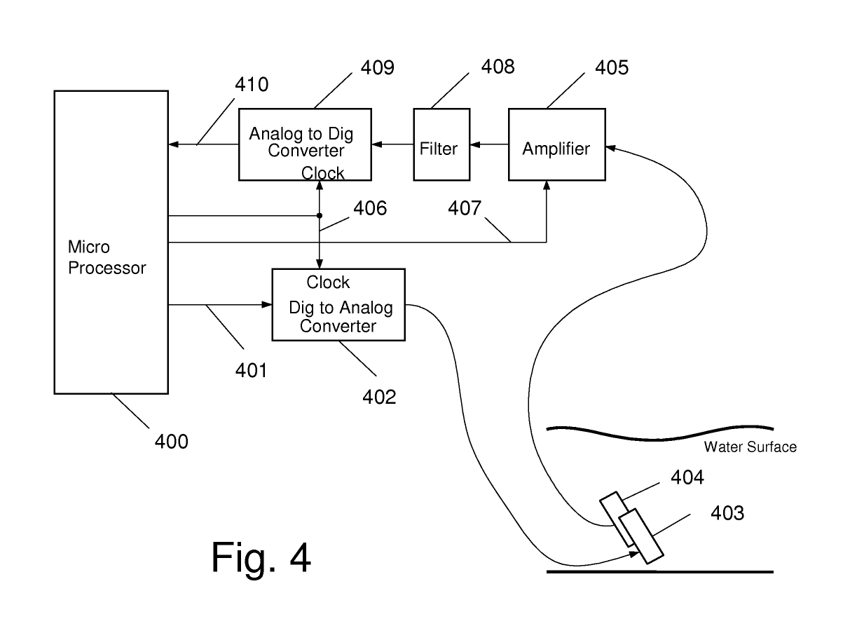

FIG. 4 is a block diagram of an exemplary sensor system illustrating the electronic aspects of the invention. Microprocessor 400 sends a 3 MHz synchronization signal 406 to both 14-bit Digital to Analog converter 402 and to 16-bit Analog to Digital converter 409. The synchronization signal controls the conversion rates and insures that all signal processing is handled coherently. Microprocessor 400 generates a data stream 401 that is sent to Digital to Analog converter 402 where it is converted into a time variant analog voltage and excites ultrasonic transmit sensor 403. Note that the amplitude and other characteristics of the transmitted signal (such as center frequency or signal magnitude as a function of time) can be controlled by controlling the data stream sent by the microprocessor. The ultrasonic signal is transmitted by transmit sensor 403 at an angle, for example, of approximately 45 degrees from the surface of the water such that the signal reflects off of particles in the water. When the signal reflects from particles in the water, at least some of the reflected energy will be received by ultrasonic receiver 404. Particles outside the beam will not be detectable. The received reflected signal will be amplified by variable amplifier 405. Microprocessor 400 can control the amount of amplification through control line 407. The amplified signal is then bandpass filtered by filter 408, digitized by Analog to Digital converter 409 and the resultant data stream 410 is stored by microprocessor 400. Alternatively, one could use either separate transmit and receive crystals 403 and 404 as shown or a single transmit receive crystal controlled by a T/R switch (not shown).

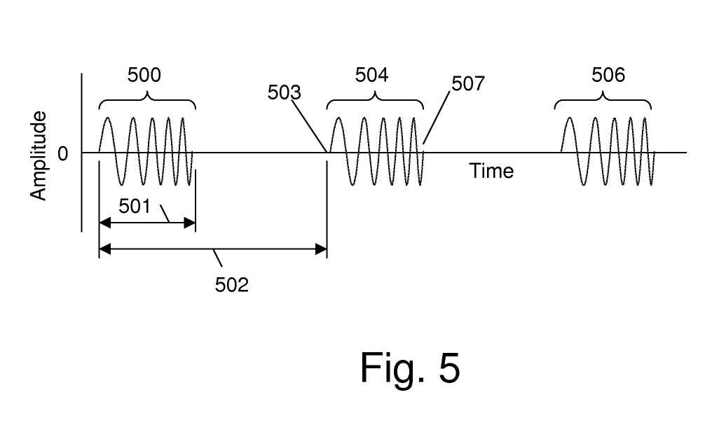

FIG. 5 is a diagram depicting an exemplary transmit signal waveform. In one embodiment of the invention, the system transmits a sequence of wide bandwidth pulses 500, 504 and 506 of ultrasonic energy. The bandwidth should be sufficiently wide to resolve individual particle echo responses and develop a trace for individual pulses. A trace may alternatively be referred to as a track or trajectory. Six cycles per pulse are shown for simplicity; however, 66 cycles would be more typical for the current experimental models. Each pulse refers to a group of cycles underlying a pulse envelope of a frequency modulated carrier waveform. The carrier is zero (off) between pulses. A pulse length 501 refers to the time period encompassing the group of cycles and not including the off time between pulses. In a preferred embodiment, the underlying carrier waveform is chirped in frequency to increase the bandwidth of the pulse. The chirp is a slewing of the carrier frequency over the interval of the pulse. The carrier frequency is typically slewed from an initial low frequency at the beginning of the pulse to a final high frequency at the end of the pulse using a linear profile in between. Pulses 500, 504, and 506 show a linear increasing frequency profile. Cycle 503 is low frequency while cycle 507 is high frequency. Alternatively, different profiles may be used. The chirp may begin with high frequencies and end with low frequencies or may use a varying profile. Alternatively, the chirp may begin with a low frequency increase linearly to a maximum and then decrease to a low frequency. In one alternative embodiment, the transmitted signal may comprise a sequence of chirps wherein each successive chirp varies in polarity according to a predetermined pattern. One exemplary pattern may be alternating polarity. Another exemplary pattern may be in accordance with a code, for example a PN code or Barker code. Alternatively, high amplitude narrow pulses or complex pseudo-random waveforms may be used. However, the chirp is advantageous in that the chirp utilizes waveform cycles of approximately equal amplitude, which are easy to generate and amplify with efficient circuits. Pulses 500, 504, and 506 are transmitted with pulse repetition interval 502. In principle, interval 502 should be set as short as possible. However, the interval should be long enough to insure that 1) the pulse has enough time to travel to and from the farthest point of interest in the flow 2) the particle travelling in the beam is visible for at least four pulses and 3) that the return signal is not contaminated by strong interfering reflections, for example, reflections that bounce off of the water surface and then return from the bottom of the pipe. As a practical matter, the repetition rate (1/pulse interval) should preferably be set between 200 Hz and 2000 Hz. Wider ranges may be used. In the exemplary embodiment, Microprocessor 400 supplies Digital to Analog converter 402 with a stream of numbers that represent a 66.67 micro-second pulse length FM chirped pulse were the underlying carrier sweeps from 850 kHz to 1.15 MHz during the 66.67 micro-second pulse. The D-A converter sample rate should at least meet the Nyquist criteria for the highest frequency in the chirp, i.e. should be greater than twice the highest chirp frequency. Similarly, A-D converter 409 should also be sampled at a rate that meets the Nyquist criteria.

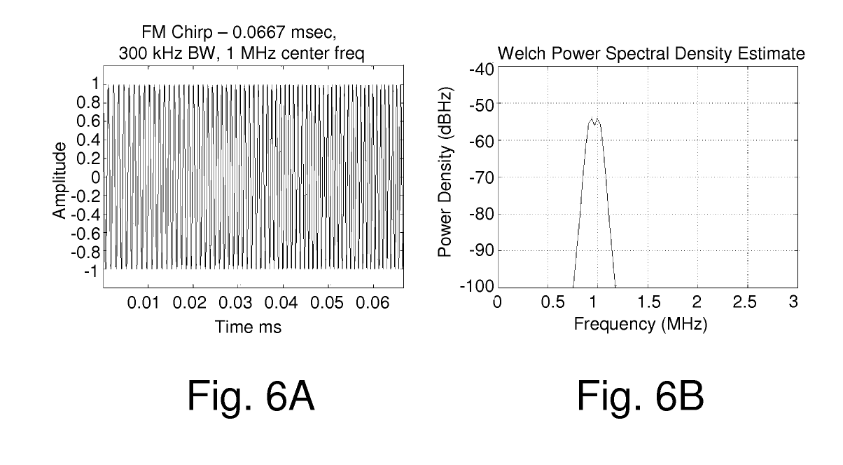

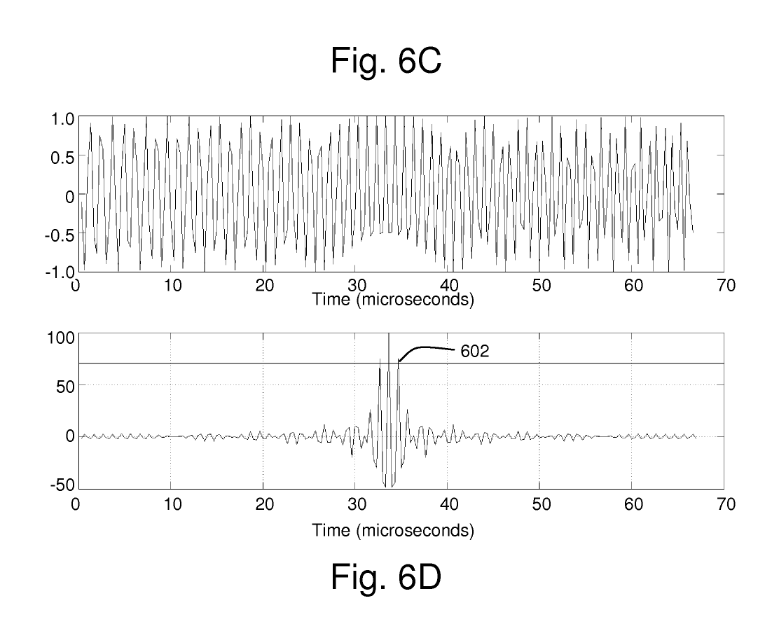

FIG. 6A shows a plot of an exemplary chirped pulse using a 66.67 microsecond pulse time and a +/−150 kHz linear slew from a 1.0 MHz center frequency. The zero signal interval between pulses is not shown. FIG. 6B shows a frequency spectrum of the plot in FIG. 6A using a Welch estimate. The chirp center frequency is preferably between 200 kHz and 10 MHz. The ratio of the high to low chirp frequency of about 1.35 is found to work well, but may be any desired ratio and is constrained by the characteristics of the transducer crystals used.

FIG. 6C illustrates an exemplary FM pulse waveform. The pulse waveform of FIG. 6C shows 67 microseconds of the pulse of FIG. 6A. A sine wave FM chirp signal is sampled at 4.0 MHz. The result including some aliasing effect is shown. The waveform of FIG. 6C is zero amplitude before and after the 67 microseconds shown. FIG. 6D illustrates a replica correlation response of waveform FIG. 6C, i.e., a waveform like FIG. 6C is received and correlated with an identical waveform replica like FIG. 6C to generate the result shown in FIG. 6D. Thus, FIG. 6D represents a match filtered echo response signal. The resulting effective pulse of FIG. 6D is thus, roughly 3 microseconds wide at a 3 dB level 602 as shown. At an echo range (round trip) velocity of 0.75 mm/microsecond in water (½ speed of sound), this results in an ability to resolve particles on the order of 2.25 mm (0.09 in) or greater separation. Other pulse structures may be used. The pulse structure should preferably be capable of resolving particles of one centimeter separation, more preferably one half centimeter separation, and more preferably one quarter centimeter separation.

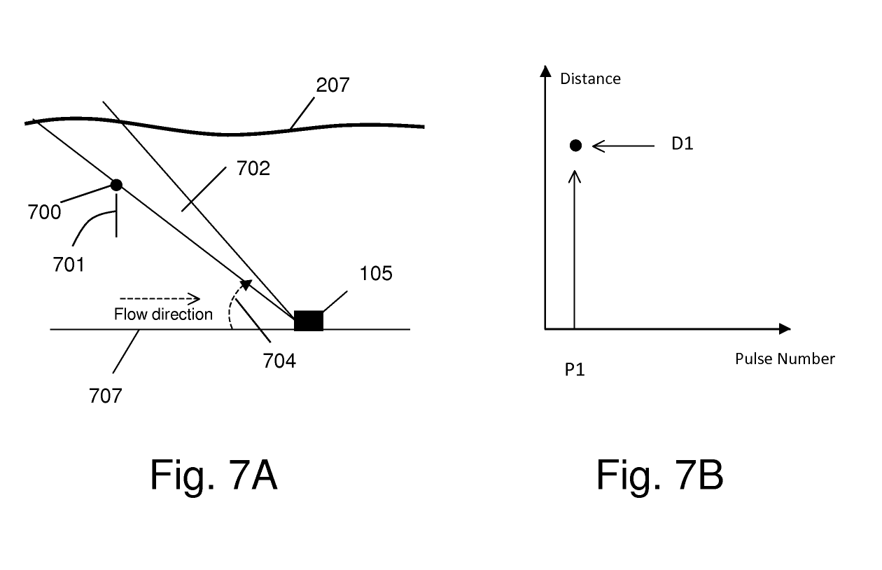

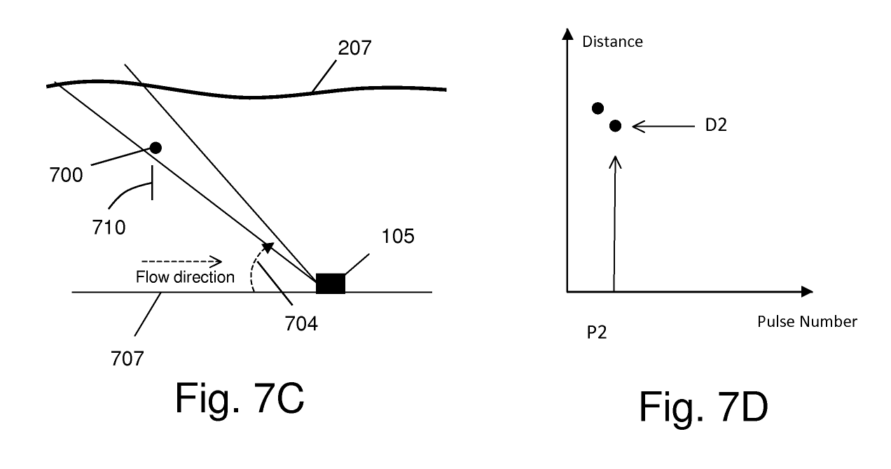

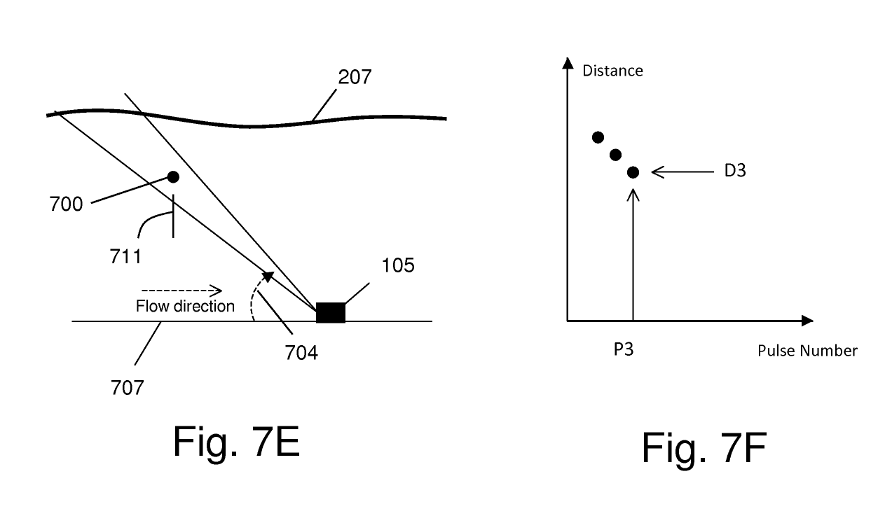

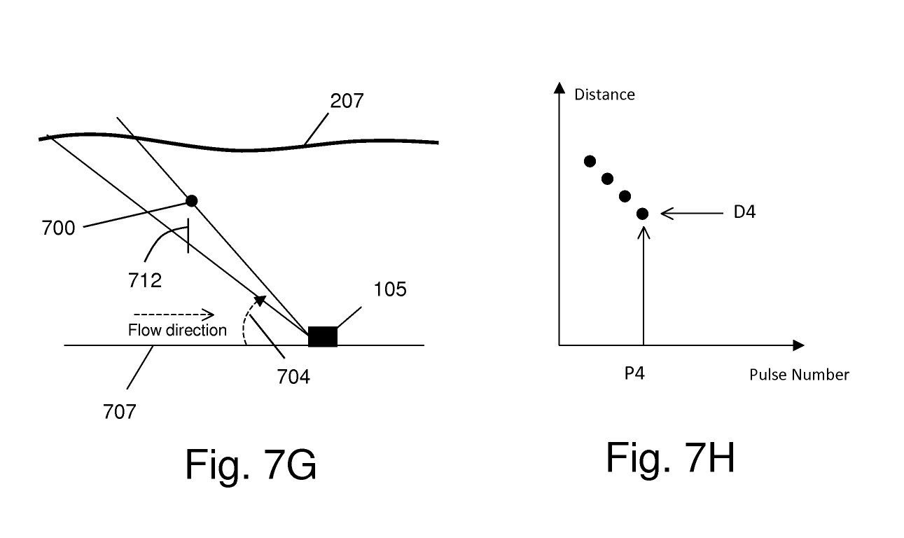

FIGS. 7A-7H illustrate the nature of the signals produced by particles moving in the flow. In FIG. 7A, sensor 105 is installed at the bottom of flow in pipe 707 and transmits a beam of energy 702 into the flow at an elevation angle 704 (alternatively referred to as a slant angle or an inclined angle). More precisely, sensor 105 is transmitting the signal waveform described in FIGS. 6A and 6B into the flow. At some point in time, a particle 700 will enter the beam at point 701. Energy from pulse P1 will reflect from the particle and will be received by the system electronics. The time between transmission of pulse P1 and its return can be converted into a measure of particle distance D1 by multiplying the signal round trip delay by the speed of sound in water and dividing by two. This is illustrated in FIG. 7B, which is a plot of distance vs. pulse transmission number. Pulse transmission number is also a measure of time because the pulse rate is constant.

FIGS. 7C and 7D show the system at a later point in time, one pulse interval later. In FIG. 7C, the particle 700 has moved to position 710 and the distance D2 is detected using pulse P2. FIG. 7D shows the accumulated position/time information for particle 700. In FIG. 7E, the particle 700 has moved to position 711 and its distance D3 is detected by pulse P3. FIG. 7F has been updated to reflect the particle location information. In FIG. 7G, the particle has moved to position 712, the downstream edge of the beam, and its distance D4 is detected by pulse P4. FIG. 7H has been updated to reflect the particle location information. There will be no subsequent detections of that particle as it has moved out of the field of view of the sensor beam. Since the graph shows the position of the particle as a function of time, the slope of the trace formed by points D1 through D4 is related to the apparent velocity of that particle. The actual velocity can be determined by compensating the apparent velocity by the cosine of angle 704. The depth at which the particle 700 is detected is computed by multiplying the distance of the trace by the sine of angle 704. The accumulated received data plot as in FIG. 7H is referred to herein as a Pulse Stack.

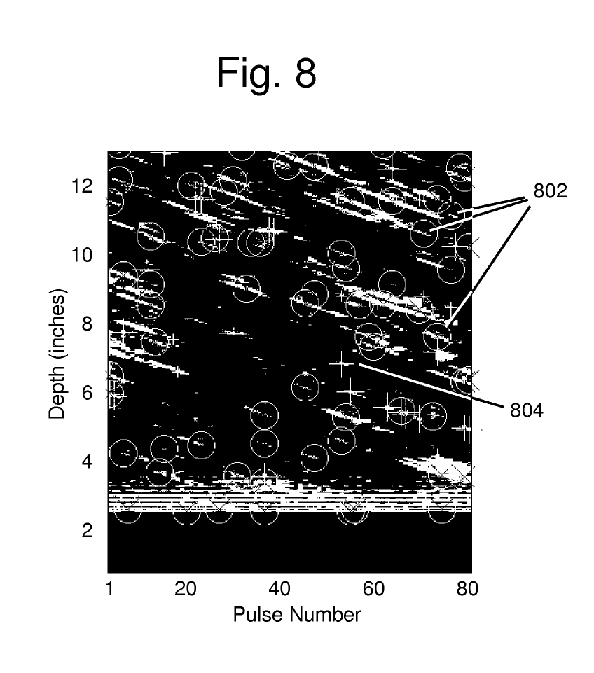

FIG. 8 illustrates a sample Pulse Stack taken in actual flow. Note that due to the large number of particles in the water, there are a great many traces in the Pulse Stack. Each of the traces marked with a white circle 802 is a viable measurement. Each of the traces marked with plus sign 804 is determined to be an invalid trace. Unmarked traces are determined to be either noise by virtue of being too small of a contiguous cluster or are an irregular shape or have a slope outside of a viable range.

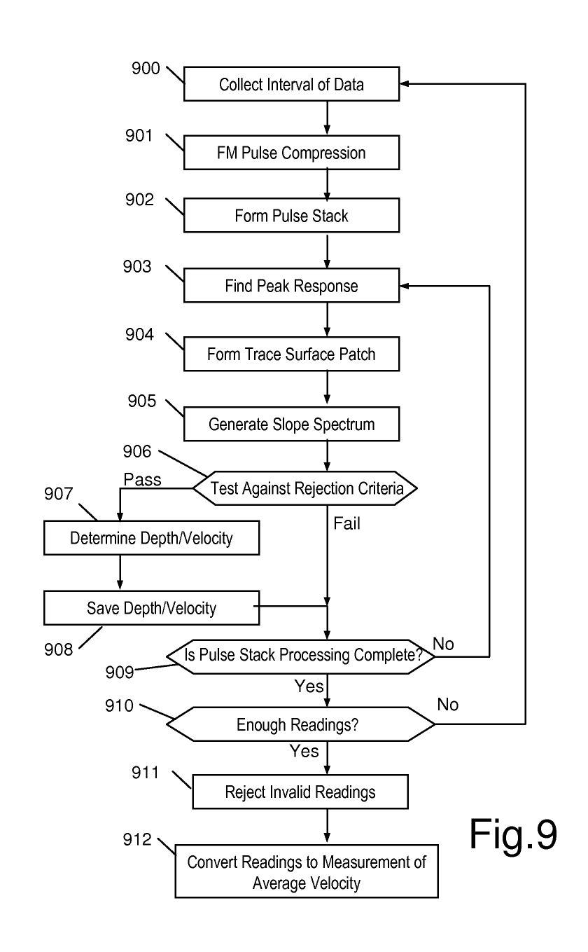

FIG. 9 is a flow chart illustrating exemplary signal processing steps. In step 900 the processor transmits a series of pulse trains into the flow and collects an interval of data, for example 160 ms of data. In step 901 the received waveforms are pulse compressed using a replica correlation process as described with reference to FIGS. 6A-6D.

In one embodiment, the system may utilize a Field Programmable Gate Array (FPGA) between the Microprocessor 400 and D-A converter 402 and A-D converter 409, to control the data flow, provide timing signals and execute the pulse compression process. In step 902 the pulse compressed data stream is arranged as a Pulse Stack. The Pulse Stack is typically stored in memory as a two dimensional array with one dimension corresponding to the X axis (pulse number) and the second dimension corresponding to the Y axis (slant range distance based on echo delay). The value stored in each memory location is the correlation response value at the corresponding echo delay time offset relative to the start of the pulse transmission.

The Pulse Stack may be plotted, as in FIG. 8. FIG. 8 is a two dimensional color mapped plot of an exemplary Pulse Stack. Referring to FIG. 8, the stream of pulse compressed data is divided into a sequence of individual pulse responses beginning with the transmission of an FM chirp and ending just prior to the transmission of the next pulse. Then the response intensity is plotted on the Y axis of a graph, positioned according to echo delay and intensity based on response value using a gray scale or color weighting. Subsequent pulse responses are plotted as vertical strips adjacent to each other to form a graph or surface referred to as a Pulse Stack. Note that the data plotted in the example Pulse Stack shown in FIG. 8 was pulse compressed.

Returning to FIG. 9, in step 903, the Processor searches the Pulse Stack for local maxima. A particle as it passes through the beam should produce a maximum reflection near the center of the beam. Thus, the local maxima should include the center of each trace and thus, the maximum is a good starting point for finding the traces.

In step 904, a patch of surface around each maximum is identified and segregated as a Trace Surface Patch. In other words, the portion of the Pulse Stack data within plus or minus a predetermined number of pulses (in the X axis) and within plus or minus a predetermined distance/delay (in the Y axis) of the selected maximum is separated for further processing.

The Trace Surface Patch is then conditioned by clearing all of the cells whose amplitude response is less than a predefined threshold, for example 40% of the maxima. The Trace Surface Patch is then processed to keep the current value of only those cells contiguous with the center cell or contiguous with cells contiguous with the center cell. All remaining cells in the patch are zeroed.

In step 905 the Trace Surface Patch is processed to find the slope associated with any trace that may be present. A Slope Spectrum is then produced by rotating a line through the central peak of the Trace Surface Patch at a set of slope hypotheses associated with the velocity range of interest (in this case −5 to 15 f/s). As the line is swept through the patch, all of the cells that intersect the line are integrated. Each line integration forms a value in the Slope Spectrum ranging from the lowest (negative) slope to the highest (positive) slope. Effectively, the Slope Spectrum represents the correlation between a line and the trace as a function of the line rotation angle about the trace maximum.

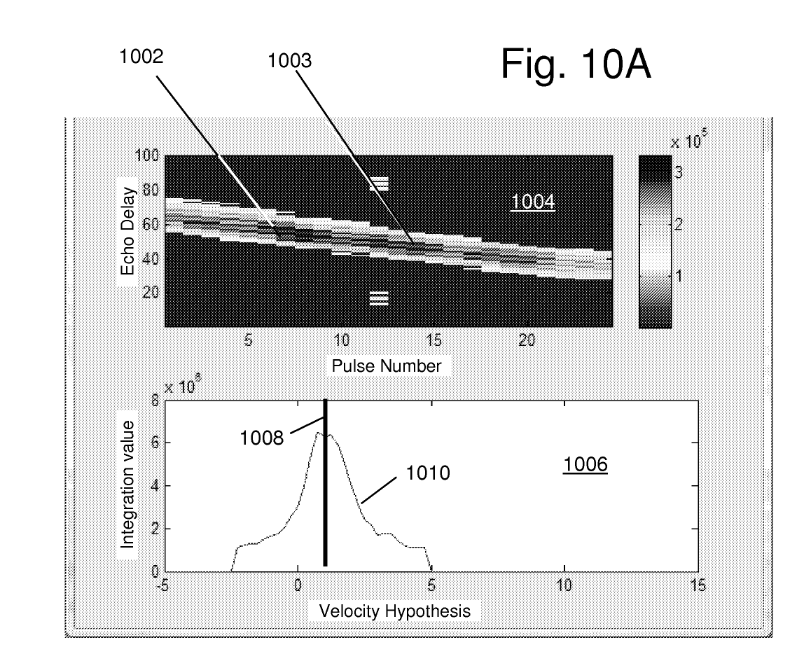

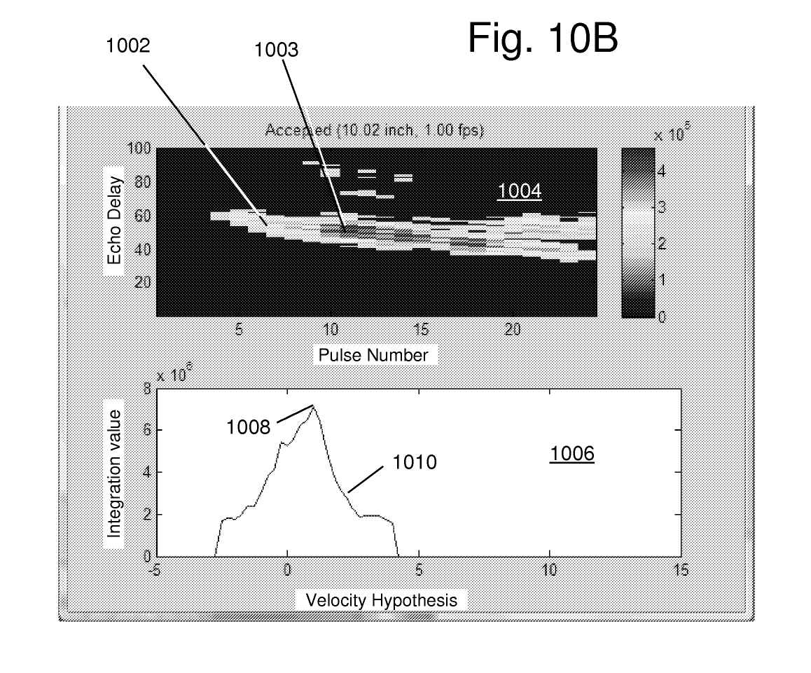

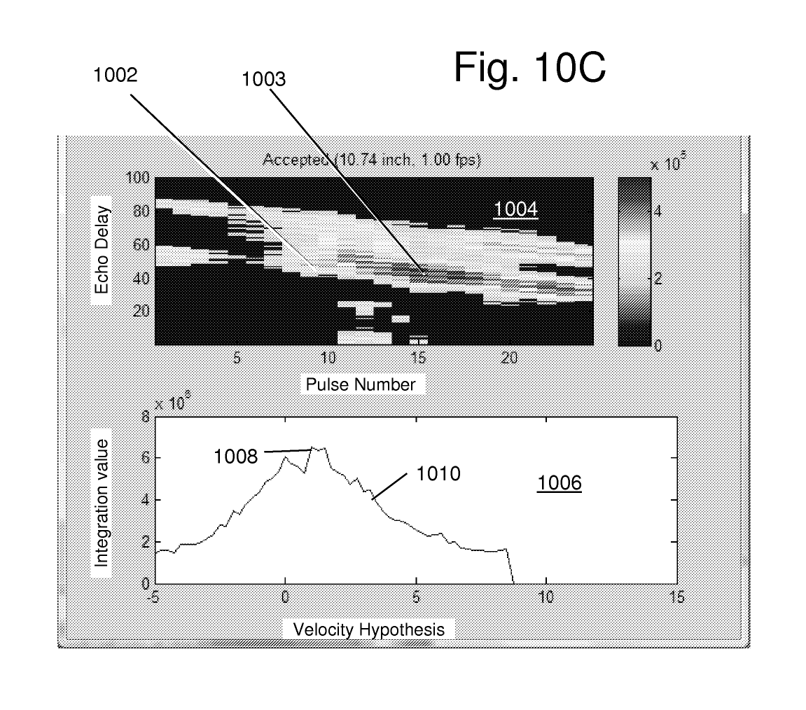

FIG. 10A FIG. 10B, and FIG. 10C show exemplary trace surface patch plots and associated slope spectra. Referring to FIG. 10, the top portion shows an example of a Trace Surface Patch 1004. The bottom portion 1006 shows a plot 1010 of the associated Slope Spectrum.

The trace surface patch display 1004 shows a patch, being a rectangular subset of a pulse stack like that of FIG. 8 centered about a local maximum value 1003. The patch fills the rectangular window 1004 as shown. The trace 1002, being the cells associated with the particle trajectory, are clearly shown as cells contiguous with the maximum value 1003. A clear slope can be seen in the trace 1002.

Note that the trace 1002 is very well behaved in that the trace produces a slope spectrum 1010 with an unambiguous peak (marked with a black line 1008) at a velocity of approximately 1.2 ft/s (0.37 meters per second). This value of 1.2 ft/s is thus the estimated velocity of the particle in question. Alternatively, the slope spectrum 1010 may be evaluated for an estimated velocity by determining a mean velocity rather than a peak velocity.

It may be noted that a wider field of view (i.e. beam widths greater than +/−10 degrees) may result in the traces having a hyperbolic curve. One embodiment of the invention would handle this by utilizing a spectrum of arc segments or curves (instead of lines) to generate the Slope Spectrum. For the narrow field of view embodiment more typically used, straight line segments yield usable and accurate slope spectrum functions.

Returning to FIG. 9, in step 906 the Slope Spectrum is evaluated for acceptability. Basically, not all maxima are indicative of particle traces and not all particle traces are useable. For example, some particles will appear to “cross” other particles. This is due to the fact that particles can have irregular trajectories and can tumble as they flow through the field of view. Multiple particles can actually cross as they flow through the water. There are other mechanisms that can produce poorly behaved slope spectra.

In one embodiment of the invention, a set of exemplary slope spectrum shape metrics may be used to identify traces that are not useful for profile measurements, keeping only those points whose spectrum is within acceptable bounds. These metrics can be summarized in two rules: the slope spectrum should have a sharp, definitive peak and that peak should be significantly stronger than the background noise. These rules may be implemented through the following two exemplary tests. The slope spectrum will be rejected if either of the following tests is failed.

1) The width of the largest peak in the slope spectrum, as measured in velocity cells at a predefined threshold level, for example the 80% of the peak value, should not be greater than a given width, for example +/−15 velocity cells wide. This test insures that the slope spectrum is reasonably sharp and definitive.

2) The peak of the velocity spectrum background should be no greater than a given threshold, for example 60% of the magnitude of the largest peak. The background does not include any cells that might occur with in a region, for example +/−60 velocity cells, of the spectrum peak. This test rejects slope spectra with inadequate signal-to-noise ratio (SNR) for measurement.

The above tests are with reference to an exemplary system using two hundred slope hypothesis values (alternatively referred to as velocity cells) for a system designed to measure over a −5 ft/sec to +15 ft/sec flow velocity range (−1.5 meters/sec to 4.6 meters/sec). Thus, each velocity cell represents an increment of 0.1 ft/sec (3 cm/sec).

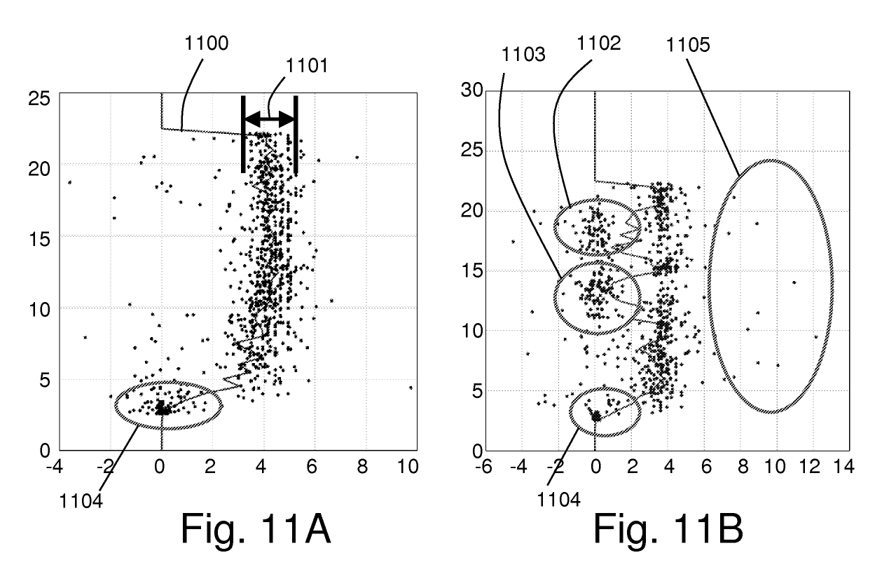

The velocity associated with the peak value of each of accepted slope spectrum (as measured in, for example, meters/sec or ft/sec) the velocity component of a Raw Profile Point associated with the trace. A raw profile point, alternatively referred to as a raw point reading is further discussed with reference to FIG. 11A and FIG. 11B.

FIG. 10B shows a display of a second exemplary trace surface patch and associated slope spectrum. Referring to FIG. 10B, the trace is shorter than the trace of FIG. 10A and has a slight irregularity toward the right side, yet produces a well behaved slope spectrum. FIG. 10C shows a display of a third exemplary trace surface patch and associated slope spectrum. Referring to FIG. 10C, the trace is more irregular than the traces of FIG. 10A and FIG. 10B. The associated slope spectrum is broader and noisier, yet still usable.

In step 907, the Raw Profile Point is converted to a Depth and Velocity reading. The apparent distance of the particle is found by the following equation:

Depth=½*(apparent round trip delay)*speed of sound in water*sine of angle 704.

The velocity is equal to the velocity 1008 associated with the maximum of the Slope Spectrum 1010 multiplied by scaling constants including the cosine of angle 704. (Alternatively, scaling constants and/or the cosine of angle 704 may be built into the slope spectrum.)

In step 908 the reading is saved to memory as a Raw Point Readings.

In step 909 the processor checks to see if all of the maxima in the 160 ms data set have been evaluated, if not then processing returns to step 903.

In step 910 the processor checks to see if sufficient Raw Point Readings have been collected. “Sufficient” can be determined in a number of ways. In one embodiment, sufficient readings are determined based on acquiring a predetermined number of sampling intervals, e.g., 100 of the 160 ms intervals. In another embodiment, sufficient readings may be based on acquiring a predetermined number of Raw Point Readings, e.g. 1000 Raw Point Readings. If more readings are required, then processing will resume at step 900, otherwise processing continues to step 911. It typically requires between 0.5 and 2 seconds of data to insure that sufficient data is collected to produce reliable readings. If insufficient measurements have been made, then a warning message can be issued.

In step 911 the processor will cull the collected Raw Point Readings for false or suspicious readings. This culling process is necessary because not all readings are meaningful. There are several reasons why readings may not be meaningful. For example, steps 904, 905, and 906 are not perfect. Also, the velocity sensor typically may have very weak side lobes that receive small amounts of energy from particles outside of the main beam. Also, the sensor may become fouled and surface or bottom reflections may interject nonsense. Furthermore, the sensor may have a blind spot of approximately the 3 inches closest to the sensor. Signals close to this boundary have a tendency to introduce noise. Further accuracy may optionally be obtained by mitigation of these issues, if desired or required. Mitigation of these issues will now be discussed with reference to FIGS. 11A and 11B.

FIG. 11A and FIG. 11B are plots of exemplary Raw Point Readings illustrating typical data patterns. These graphs are plots of the Raw Point Readings taken during a sequence of measurements. Depth, as measured by height above the bottom of the pipe, is indicated along the vertical Y-axis. (Note that depth, within this disclosure, may be measured from the bottom of the pipe in an upward direction or may be measured from the surface of the water down, depending on context.) Velocity is indicated along the horizontal x-axis. Note that the points in FIG. 11A are bunched about line 1100 (the mean of the points as a function of depth). These points vary from line 1100 by an amount roughly indicated by range 1101. These deviations are the result of random paths that particles take as they move and tumble through the flow, random speeds of the particles as well as inaccuracies in the slope estimation process. Additionally, note the clump of points about zero velocity indicated by oval 1104. Such points can be caused by noise in the sensor blind spot or debris on the sensor. The data in FIG. 11A is otherwise almost perfect. FIG. 11b shows reduced low depth scatter at 1104 but has significant amounts of surface scatter noise 1102 and sidelobe surface scatter noise 1103. Note also the extraneous readings in oval 1105. The 1105 points are likely caused by imperfections in the software signal processing. Noise can be dealt with by either ignoring the occasional odd average velocity reading or by suppressing the noise mechanisms. One embodiment uses the following approach. The probability distribution of the points is estimated. If the distribution is bimodal, then the points about the slower distribution are eliminated from consideration. This effectively deals with the surface, sidelobe and shallow flow false zeros. The median, mean and standard deviation of the resultant points are computed and all points outside of one standard deviation from the mean are excluded. In another embodiment, the computation may be performed on all of the data as a whole, i.e., all data from all depths are grouped together for forming mean, deviation and distribution calculations. In another embodiment, the points may be sorted into a number of depth related bins and the computations may be performed separately on each bin. For example, with respect to FIG. 11A, the data may be grouped into bins for each 5 inches (12.5 cm) in depth for computation of a mean and standard deviation. Points outside of one standard deviation from the mean for each bin may be rejected. The remaining points may be used for determining a new mean, which would be an improved mean velocity estimate by virtue of eliminating a number of error and noise points.

A bimodal data distribution may be detected by first filtering the distribution data to smooth the data, for example, grouping the data into velocity bins, or running a running average filter having a predetermined filter width and plotting the filtered distribution, number of points within the bin or filter width as a function of velocity. The filtered distribution may then be searched for a peak to the side of the maximum peak. If the second peak meets a height requirement and a spacing requirement and the dip between peaks meets a dip requirement, then the process may remove the data lower than the velocity of the minimum point of the dip between the two peaks.

### Average Slope Spectrum

In an alternative embodiment, the valid slope spectra may be summed to produce a summed or averaged slope spectrum. The averaged slope spectrum may then be evaluated for the velocity at the peak of the average response to produce the average measured velocity. The average measured velocity may then be used to derive an average flow velocity according to methods described herein.

Returning to FIG. 9, step 912 is the conversion of the Raw Point Readings into a measure of average velocity (average of Raw Point Readings—not to be confused with average flow velocity, discussed later). In one embodiment of the invention all of the unculled Raw Point Readings between sensor short range blind spot (approximately 3″ (7.6 cm)) and the surface are averaged to provide a result. If the pipe is full, then readings close to the far wall (the far wall blind spot) are also ignored as these particle responses are corrupted by beam reflections from far wall. In a further embodiment, the result can be improved in shallow water situations by processing the received data from a time delay corresponding to the short range blind spot minimum to the surface and all reflections of the beam from the surface to within 0.5″ (1.27 cm) of the bottom.

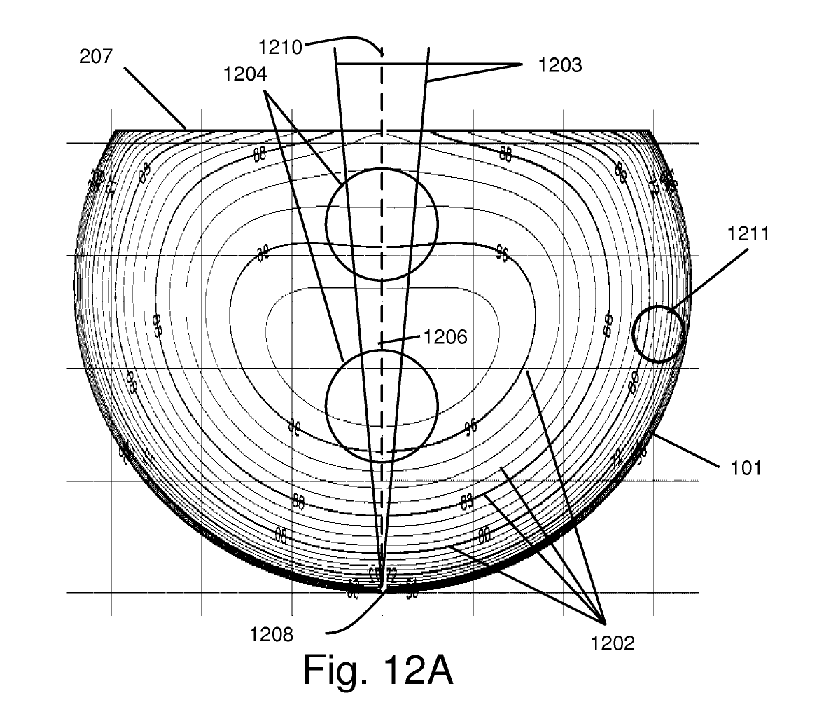

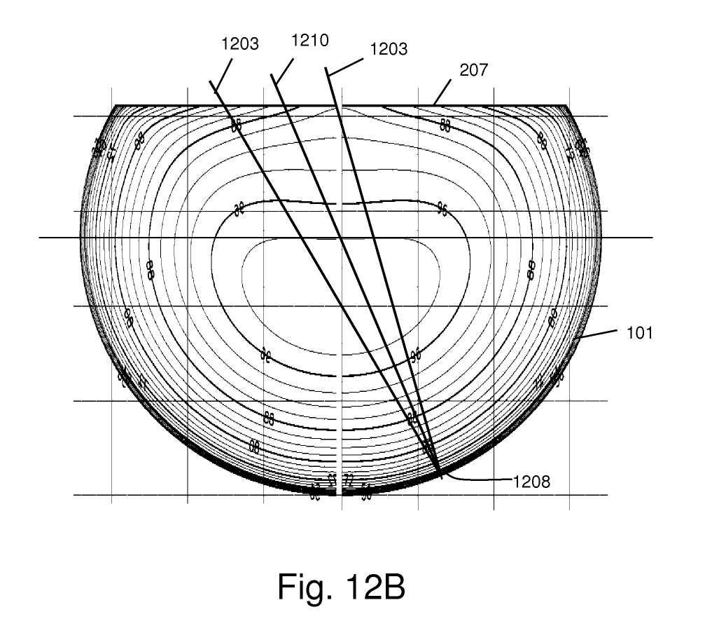

FIG. 12A illustrates a finite element model of an exemplary flow cross section of a partially filled round pipe showing contour lines of constant velocity. FIG. 12A also shows exemplary regions of velocity sensing within the flow. In accordance with one embodiment, the ultrasonic receiver is configured for determining an average particle velocity within one or more flow measurement regions, each defined by an associated proximal range limit and a distal range limit along the path of the ultrasonic beam. Within this disclosure, in the context of total flow through the pipe, average velocity or average flow velocity means a velocity value which when multiplied by the pipe flow cross section yields the total flow rate through the pipe. The pipe flow cross section is the cross section perpendicular to the pipe axis and perpendicular to the flow direction of the flow within the pipe, bounded by the pipe walls and the flow surface. Total flow and total flow rate refer to the flow crossing a pipe cross section in volume per time, e.g., cubic meters per minute. Average velocity is in distance per time, e.g., meters per minute.

In various embodiments of the invention, it is desired to utilize the raw point velocity readings to determine an average flow velocity for total flow computation.

In one embodiment, the deep water processing time can by improved by limiting the depths searched to just a few areas as illustrated in FIG. 12A. FIG. 12A shows round pipe 101 filled to surface 207 with flowing water. Lines of constant velocity 1202 are shown as computed by a finite element model and marked as percent of maximum. The maximum flow rate is at reference 1206. The contours each represent two percent and are labeled at 96%, 88%, 80%, 72%, 64% and 56%. The field of view of the velocity sensor is marked by boundary lines 1203 each side of the ultrasonic beam center line 1210. Exemplary flow areas evaluated by the velocity sensor are denoted by circles 1204. For example, the area evaluated by the software signal processing may be the area common to boundary lines 1203 and circles 1204. Exemplary circles 1204 are shown at 20% and 60% of the depth. (Depth measured from the surface of the water in a downward direction.) Other regions may be used, or the entire beam 1203 may be used. More particularly, computation may be limited to a range of depth values representing a subset measurement volume of the flow. The range of depth values may alternatively be referred to as a depth bin. Depth may be determined as the depth of each trace based on the slant range delay (distance) to the center of the trace at the elevation angle of the beam. For example, evaluation of an average measurement velocity for the 20% depth circle 1204 may be accomplished by evaluating traces within a range of depths surrounding the 20% depth. The range of depths may include for example +−5%, alternately specified as a range from 15% depth to 25% depth. The average velocity for all traces within the 15% depth to 25% depth bin may be considered an average measured velocity for the 20% depth level. The 15% and 25% depth limits may be translated to slant range delay values by using the beam elevation angle and any other necessary mounting geometry information. Thus, the depth bin limits may be defined by an associated proximal range limit (associated with the 25% depth) and a distal range limit (associated with the 15% depth) along the path of the ultrasonic beam. In one embodiment, the depth range may include the center maximum value 1206 of the flow, typically near the center of the flow cross section, i.e., half way between each side of the pipe and half way between the surface and the bottom of the pipe. In one embodiment, the measurement volume is within the center half, or within the center two thirds of the flow cross section. (The center fraction being with respect to each vertical or horizontal dimension.) In another embodiment, the subset measurement volume may be placed within the estimated 90% to 100% of maximum velocity contours. In one embodiment one or more regions 1204 defined by depth limits may be evaluated for velocity. Two regions 1204 are shown in FIG. 12A, but any number may be used. Limiting software signal processing to a reduced area significantly reduces the compute time.

In one embodiment, the average flow velocity is determined by using a computer finite element model to model flow velocity in a flow regime related to the measurement case, i.e., having similar dimensions, depth, pipe roughness, and velocity. The model is used to determine average velocity in a measurement region of the flow that is measured by the ultrasonic sensor. The model is also used to determine an average flow velocity relating to the total flow bounded by the pipe walls and water surface such that the average flow velocity multiplied by the flow cross section gives the volumetric flow rate in volume per time units. A conversion factor can then be determined as the ratio of average whole area flow velocity divided by average measurement region flow velocity. Valid Raw Point Velocity readings in the measurement region may be averaged to yield an average measurement region velocity. The result is then multiplied by the conversion factor to yield the average (flow cross section) whole area flow velocity. Volumetric flow may then be obtained by multiplying the whole area flow velocity by the flow cross section area.

This approach can be extended to situations where the sensor is not mounted on the bottom of the flow. In many sites, it is not practical or possible or meaningful to mount the sensor on the bottom of the flow. Instead, the sensor location is shifted off of the center of the pipe and is rotated up the side of the pipe. This is typically done to avoid a thick layer of silt or gravel that might be located on the bottom. The off center sensor location is accommodated by basing the profile velocity reading to average velocity conversion factor on a model that includes the angle of rotation.

FIG. 12B illustrates an alternative embodiment wherein the transducer is mounted laterally from the center bottom of the pipe 101. Referring to FIG. 12B, the transducer mounting point 1208 is seen to be shifted to the right to avoid sediment that may contaminate the sensor at the very bottom of the pipe. The sensor beam is depicted by showing beam edges 1203 and beam center 1210. In addition to shifting the mounting point, the beam is rotated to direct the beam toward the center of the pipe. Other rotation angles may be used. The beam now intersects a slightly different portion of the flow cross section. Thus, the calculation of the relationship between average measured flow and average total flow is now based on the flow model as it overlays the beam geometry for the shifted beam.

### Average Velocity

Average velocity relating to the entire flow cross section may be obtained from flow measurement velocity readings by various methods now described.

In one embodiment, average flow velocity may be obtained by modifying a procedure recommended in the velocity measurement standard ISO 748:1997.

ISO 748:1997 outlines several methods for determining an average flow velocity based on numerous velocity probe measurements. Various methods using various probe types and locations and associated formulae are provided. One method utilizes numerous probe depths along numerous vertical locations along a flow cross section. Probe depths of 20%, 60%, and/or 80% are utilized in several reduced point methods. Probe measurements are combined in accordance with formulae provided.

In accordance with one embodiment, average velocity may be determined by ultrasonic beam and associated processing as previously described herein for each vertical selected in accordance with ISO 748 and then combined in accordance with ISO formulae. This may require multiple transducers or moving a single transducer from one vertical to the next.

In an alternative non-ISO embodiment, average velocity may be determined using a single vertical and one or more subset measurement volumes to determine a subset average velocity and then relating the subset average velocity to a total flow average velocity by using relationships developed based on a finite element simulation.

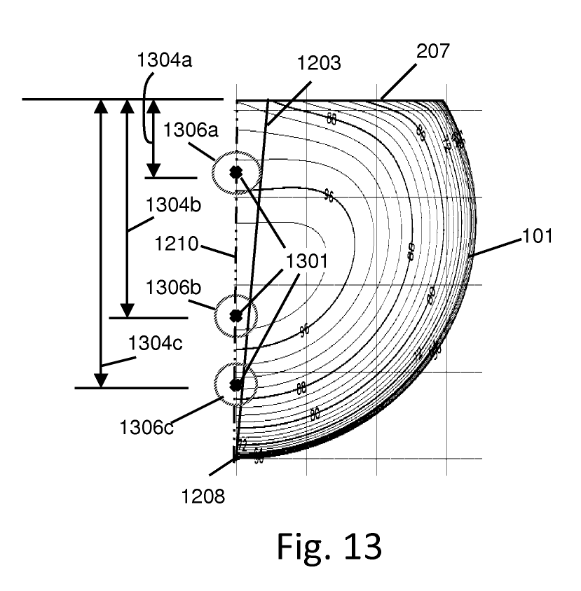

FIG. 13 illustrates exemplary flow measurement in a 54 inch (137 cm) diameter pipe, 75% full, using 5 inch (12.5 cm) measurement regions. Referring to FIG. 13, the areas marked by circles were positioned at 20%, 60% and 80% points. The size of each area was selected as 5″ based on balancing considerations for measurement speed and accuracy vs. considerations for computation time. Larger areas will yield more particle traces, but will require more computation time. Referring to FIG. 13, the pipe is shown with flow filling 75% of the diameter. Iso-velocity (iso prefix meaning same velocity) contour lines are shown as percent of maximum velocity. A half pipe is shown for drawing convenience and clarity. The ultrasonic beam is directed upward from the center of the bottom of the pipe toward the surface of the water at a slant angle. The slant angle is not visible from this perspective. A beam center and beam edge are shown as projected on the flow cross section. Three five inch (12.5 cm) diameter circles 1306a-1306c are shown denoting measurement regions about depth levels representing 20% (1304a), 60% (1304b), and 80% (1304c) from the surface. In one embodiment, traces having depth measurements within each respective region are used to determine an average velocity for each respective region.

FIG. 13 shows three exemplary measurement regions 1306a-1306c. Any number of regions may be used. A point average velocity for the traces having depth readings within each region is developed for each point 1301. The three point averages are then averaged with equal weight to form an average profile velocity, Vₘₑₐₛ. Vₘₑₐₛ may then be used to determine a total average flow velocity. In one embodiment, the average profile velocity may be used directly as the average flow velocity. Points 301 may be selected to produce a Vₘₑₐₛ which is a reasonable estimate of average flow velocity, or which may be converted to average flow velocity with a multiplying factor. Optionally, greater accuracy may be achieved by further techniques, as will now be described.

### Measurement Velocity and Flow Velocity

The following is a description of the process by which one can determine the relationship between measurements of particle velocity and the average total flow velocity and then use that relationship to determine average total flow velocity from a set of measurements.

First, a finite element model is used to generate flow velocity cross section information for a range of flow conditions. The range may include permutations of multiple parameters including pipe sizes, fill percentages, pipe slopes, pipe shapes, surfaces roughness values, and flow velocities. The model defines a flow cross section surface normal to the flow, typically normal to the pipe axis. Flow velocity is evaluated for each point in the plane. Flow normal to the cross section plane is evaluated as a long term average to average the short time effects of turbulence. The data may be plotted using iso-velocity lines for each given flow condition. The units of the iso lines may be a percentage of the peak velocity as displayed in this disclosure. From each flow condition, an average total flow velocity may be determined as a fraction of the peak velocity.

$${K}_{1} = \frac{{V}_{avg}}{{V}_{pk}} \qquad$$

Where, K₁ is the average to peak ratio;

V_{avg} is the average total flow velocity, averaged over the entire cross section; and

Vₚₖ is the peak velocity within the cross section.

In a second step, one or more regions where flow readings will be taken by the ultrasonic sensor are identified in the velocity cross section data. For each measurement region an average velocity factor K2 is determined by integrating (summing) the fractional peak values over the area of the flow cross section corresponding to the measurement volume. The resulting average fractional peak value V_{prof} is the average velocity fraction for the measured volume:

V_{prof}=K₂Vₚₖ

where,

V_{prof} is an average profile velocity in the measurement area;

Vₚₖ is the peak velocity within the cross section; and

K₂ is the ratio of V_{prof} to Vₚₖ.

Define the area in the finite element where the flow readings will be taken by the ultrasonic sensor. For this area, compute the average of the measured area as weighted by the iso-velocity areas. The units of this measurement will be percent of peak velocity.

The ultrasonic sensor will measure the velocity of the particles in the measurement area as previously described. An average of the velocity measurements taken associated with the measurement volume is Vₘₑₐₛ. Vₘₑₐₛ is a measurement of V_{prof}.

Combining equations 2 and 4 yields the following:

$$\frac{{V}_{avg}}{{K}_{1}} = \frac{{V}_{prof}}{{K}_{2}}$$

Ideally, one may repeat this process for all expected depths, velocities, pipe shapes, pipe roughness values, and pipe slopes. Doing so will produce values of K₁ and K₂ for all expected flow conditions. In practice, reasonable values for K₁ and K₂ can be produced using a limited number of flow conditions. Interpolation may be used to generate intermediate conditions.

V_{avg} may then be determined from measurements by substituting Vₘₑₐₛ for V_{prof} as follows. Starting with an initial estimate of flow velocity, a flow parameter set may be selected from which K₁ and K₂ may be determined. V_{avg} may then be calculated:

$${V}_{avg} = \frac{{K}_{1}}{{K}_{2}} {V}_{meas}$$

K₁ and K₂ may depend slightly on the flow velocity because the flow profile may depend on the degree of turbulent flow development. Thus, in one embodiment, an initial estimate of flow velocity may be taken as equal to the measurement. Alternatively, the initial estimate may be from a recently completed flow calculation. Alternatively, the flow velocity dependency of K₁ and K₂ may be reduced to a function of velocity measurement and K₁ and K₂ directly computed. One iteration is typically sufficient. For greater accuracy, more iterations may be run.

### Laboratory Measurements

Both the depth bin and modeling approaches typically have limited applicability to shallow flows. For flows of a few inches, it is difficult to apply the depth bin approach of FIG. 13 because the 20, 60 and 80% points are too close together to separately measure the velocity. Typically available generic finite element model based flow results are difficult to adapt to shallow flow because the implementation assumes that the combination of ring, sensors and cabling is negligibly small compared to the flow. Consequently, it may be advantageous to utilize empirically derived flow data for shallow flow conditions. Lab tests may be run to relate Raw Point Reading to flow velocity by basing a Raw Point Reading to average flow velocity conversion factor on empirical measurements using a high accuracy reference such as a magnetic meter, displacement meter, or dead weight measurement system. In one embodiment of the invention, empirical lab test data is used for flows having a depth less than a predefined level, for example 3 inches (7.5 cm), and computer model derived factors are used for deeper flow.

This process may further be described mathematically by the following. The volumetric flow is the product of an average flow velocity times the cross section area:

Q=V_{S}A_{f}

where,

Q is the volumetric flow in volume per time units, e.g., cubic meters per minute.
V_{S} is the average flow velocity normal to the flow cross section plane; and
A_{f} is the area of the flow cross section plane normal to the average flow vector. The flow cross section area is the area bounded by the pipe wall and surface of the water.
Thus, the average flow velocity may be defined as:

V_{S}=Q/A_{f}

In accordance with the invention, the system measures the velocity of a number N of particles within a subset measurement volume of flow, i.e., within the ultrasonic beam and bounded by predetermined depth limits. The individual particle measurements ν_{Pn} may be averaged:

$${V}_{P} = \frac{1}{N} {\sum }_{N} {v}_{Pn}$$

where,

V_{P} is the average point velocity measurement in the measurement volume;
N is the total number of velocity measurements in the measurement volume; and
ν_{Pn} is each nth individual velocity measurement in the measurement region of the flow. The ν_{Pn} measurements are the qualified and corrected valid measurements, having applied any corrections necessary to achieve the desired accuracy.
The average point velocity V_{P} is used to estimate the average flow velocity by use of a conversion factor:

$${C}_{P} = \frac{{V}_{s}}{{V}_{P}}$$

where,

C_{P} is the ratio of average flow velocity in the full flow cross section to the average point velocity in the measured velocity of the flow. C_{P} is not known directly, however, using simulation or other fluid dynamic information, one can determine an estimate:

$${C}_{M} = \frac{{V}_{s}}{{V}_{M}}$$

where,

C_{M} is the ratio of average flow velocity over the flow cross section to the average flow velocity V_{M} over the same subset measurement volume region as V_{P} but as determined by simulation or other fluid dynamic information.
In practice C_{M} is taken as approximately equal to C_{P}. Thus, we can determine C_{M} from simulation and:

C_{P}=C_{M}

V_{S}=C_{P}V_{P}

Q=C_{P}V_{P}A_{f}

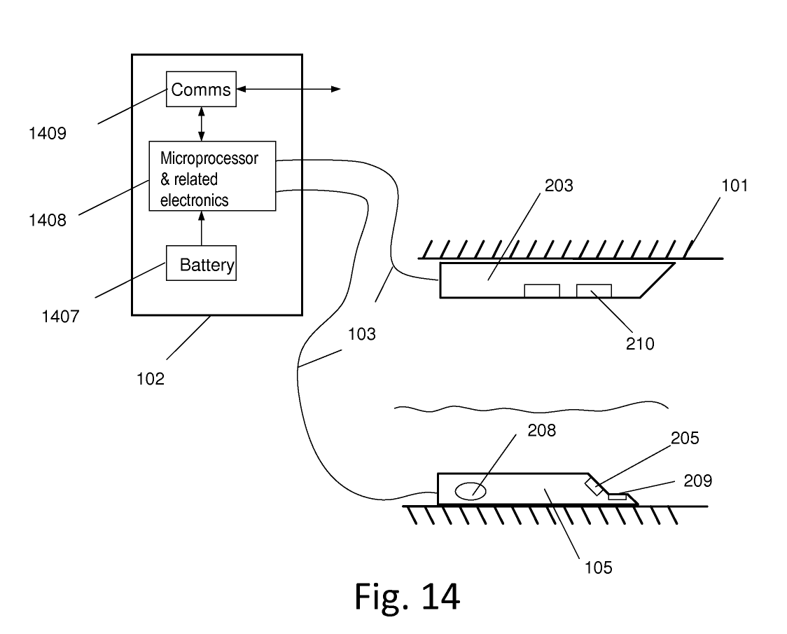

FIG. 14 is a diagram illustrating how the invention may be incorporated into a system to provide flow measurements as part of an instrument installed in a drain pipe. Sensor enclosure 204 is installed on a ring and crank assembly (not shown) in sewer pipe 101. Sensor enclosure 204 contains ultrasonic ranging sensor 209 that measures the distance to the surface, pressure sensor 208 for measuring depth in the pipe and surcharge depth when the pipe fills and velocity sensor 205. It addition, it is also possible to mount optional sensor enclosure 203 at the top of the pipe on the same ring and crank assembly used for sensor enclosure 204 and measure the distance to the surface with ultrasonic ranging sensor 210. The sensor enclosures are connected by cables 103 to water proof enclosure 102. Enclosure 102 contains battery 1407 which powers electronics 1408 and communications device 1409. Electronics 1408 contains regulators, processors, memory, signal processing electronics and all related devices that allow the unit to act as a data logger. One of the functions that it provides is the conversion of the range, pressure and velocity readings taken by the various sensors into a measure of depth, average velocity and, if the site is surcharged (filled and pressurized), the pressure head. This conversion requires that the operator measure the pipe geometry and manually load that information into the electronics. With this information, the processor in electronics 1408 can convert the depth or range measurements into a measure of the cross-sectional area of the flow. The processor in electronics 1408 can then multiply the cross-sectional area by the average velocity and produce a measure of the flow rate. The resultant value can be stored in memory, displayed locally and/or at some point in time transmitted via communications unit 1409. Communications unit 1409 can utilize any of a variety of communications technologies including, but not limited to, a local LCD display, 4-20 ma current loop, RS232, RS485, USB, MODBUS, Bluetooth, Zigbee, Land Line telephone modem, ISDN, DSL, GSM cell phone, or a variety of short and long haul radios.

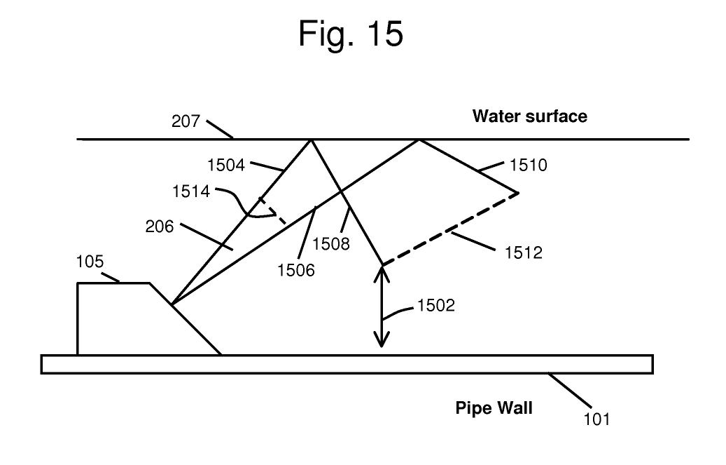

FIG. 15 illustrates a side view of a measurement volume including a volume covered by reflecting the ultrasonic beam by the surface of the water. Referring to FIG. 15, the ultrasonic transducer module 105 directs the ultrasonic beam 206 upward toward the water surface 207. The beam lateral edges may be defined typically as some attenuation point, for example 6 dB down from a center peak response and may be indicated as 1504 and 1506 in FIG. 15. The ultrasonic beam coverage may be extended by reflecting the beam off of the water surface 207. The edges of the extended beam are indicated by 1508 and 1510, the reflected edges corresponding to edges 1504 and 1506 respectively.

The extent of additional coverage is controlled by establishing a timing or equivalently, a distance (range) from the sensor within which reflections will be processed. The limit distance produces a boundary 1512. Thus, the measurement volume within which particles may be sensed and measured is the volume within the lateral extend of the beam out to the limit range in accordance with a reflection off of the surface of the water. The limit range may be selected to prevent sensing flow too close to the pipe wall 101. Thus, in one embodiment a limit range may be calculated based on a measured water depth, known sensor beam angle, beam width, and a predetermined safety margin distance 1502 (also referred to as an exclusion zone) in accordance with the geometry of FIG. 15. The safety margin distance 1502 may be selected based on experiment for similar pipes. A distance of, for example, 5 centimeters (2 inches) works well for many applications. In one embodiment, the reflection may include echoes up to a range of twice the distance from the transducer to the surface. This will produce a reflected beam equal in length to the upward beam, extending down to the level of the transducer on the reflected beam portion.

When the pipe is full or nearly full, one may also place an additional margin distance at the top of the pipe to reject particles detected within the top safety margin distances. Particle echo returns may be determined to be within the top margin based on echo return delay and the known transducer mounting point and beam elevation angle information.

The ability to sense using reflected beam allows greater sensing volume, which can be especially valuable in low flow depths. The sensor blind range 1514 limits sensing in low flows. For example a sensor blind range of 7.5 cm (3 inches) limits sensing to 2.5 cm in a 10 cm flow depth. However, by sensing reflected volume down to 5 cm, the sensing may include 5 cm of depth.

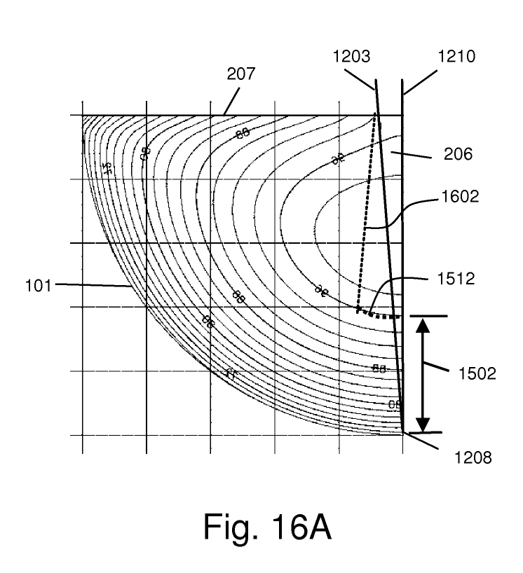

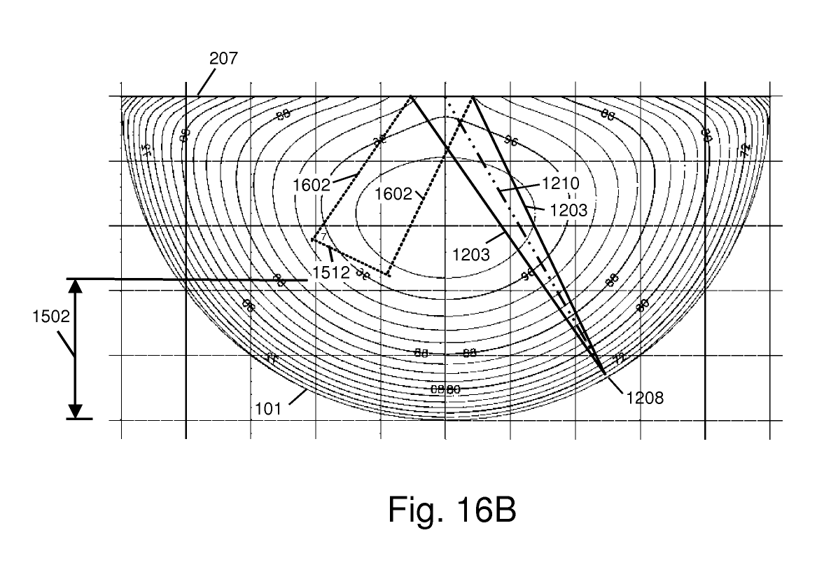

FIG. 16A and FIG. 16B illustrate an exemplary measurement volume associated with reflecting the ultrasonic beam off of the surface of the flow in accordance with FIG. 15. Referring to FIG. 16A. FIG. 16A shows a cross section of a pipe flow perpendicular to the pipe cylindrical axis. The left side is shown. The right side is symmetrical and not shown for drawing convenience. The pipe flow is bounded by the pipe wall 101 and surface 207 of the flow. Equal velocity contours are shown for the exemplary flow. The ultrasonic transducer position 1208 is shown at the center of the bottom of the pipe and directed upward at a slant angle. A projection of the beam 206 as seen viewing parallel to the pipe axis is shown. The beam center line 1210 and upward beam edge 1203 are shown. The measurement volume from the reflected beam is shown bounded by the reflected lateral beam edge 1602, the water surface 207, and the maximum range value 1512 used for processing traces as described with reference to FIG. 15. Thus, it can be seen that significant additional measurement volume may be achieved by using the reflected beam and the additional measurement volume can probe shallower parts of the flow that are otherwise sparsely probed or unavailable to the upward beam.

FIG. 16B illustrates an exemplary measurement volume for an off center sensor location 1208 that utilizes a reflection off of the surface of the water. Left and right sides of the flow are shown to better illustrate the asymmetry of the beam coverage. The sensor location 1208 is rotated off center, up the side of the pipe 101. The sensor is directed perpendicular to a tangent to the pipe circumference, resulting in a beam through the center of the pipe. Other beam direction angles may be used. The beam is at a slant angle as previously described. The upward beam is defined by the centerline 1210 and lateral edges 1203 as shown. the reflected beam defines a measurement volume bounded by the reflected beam lateral edges 1602, the water surface 207, and the maximum range 1512 to be processed. The maximum range 1512 may be defined based on a exclusion zone 1502 at the bottom of the pipe. One can see from FIG. 16B that the additional flow volume probed by the reflected beam may be significant.

FIGS. 15-16B show the measurement region may be bounded by a distance along the beam including a reflection from a surface of the water and extending downward from the reflection to and not beyond a predetermined distance from a bottom of the pipe.

In a further feature, the beam is directed to reflect from the surface of the water to extend the measurement region below a blind range of the sensor and to avoid an exclusion zone above the bottom of the pipe.

In a further embodiment, the ultrasonic beam reflects from a surface of the water and the measurement region is bounded by an echo return delay corresponding to an echo range distance 1512 of not more than twice the distance from the transducer or transducer mounting surface to the surface of the water along the direction of the ultrasonic beam.

In a further embodiment, the measurement region is further bounded by a predefined distance 1502 from a bottom of the pipe to exclude reflections from a flow region near the bottom of the pipe within the predefined distance.

### CONCLUSION

Thus, herein described is a flow sensor that accurately and economically measures flow velocity, including low flow and reverse flow, in a pipe over the full range of fill percentages without substantially interfering with the flow and may operate for extended periods in remote unattended locations.

The present invention has been described above with the aid of functional building blocks illustrating the performance of specified functions and relationships thereof. The boundaries of these functional building blocks have been arbitrarily defined herein for the convenience of the description. Alternate boundaries can be defined so long as the specified functions and relationships thereof are appropriately performed. Any such alternate boundaries are thus within the scope and spirit of the claimed invention. One skilled in the art will recognize that these functional building blocks can be implemented by discrete components, application specific integrated circuits, processors executing appropriate software and the like or any combination thereof.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. A system for measuring a total flow rate of a flow in a partially or completely filled pipe, comprising:
an ultrasonic transmitter configured for transmitting a transmitted ultrasonic signal;
said transmitted ultrasonic signal comprising a sequence of wide band pulses;
said ultrasonic transmitter comprising a transducer configured for disposition at or near a bottom of said pipe and configured for producing an ultrasonic beam of said transmitted ultrasonic signal, said ultrasonic beam directed upward at a predetermined elevation angle into said flow, said ultrasonic beam having a predetermined beam width angle;
an ultrasonic receiver configured for receiving reflected signals produced by said transmitted ultrasonic signal reflecting from objects in said flow;
said ultrasonic receiver configured for processing said reflected signals to identify a plurality of individual particle trajectories, each individual particle trajectory of said plurality of individual particle trajectories based on a plurality of wide band pulses of said sequence of wide band pulses; said ultrasonic receiver configured for processing each said individual particle trajectory to determine a respective velocity and associated particle depth for each said individual particle trajectory;
said system further comprising a flow depth sensor for producing a flow depth measurement; said system having pipe geometry information for said pipe; said system combining said flow depth measurement, and said pipe geometry information, with said individual particle trajectories and associated particle depths to determine an average flow velocity relating to said total flow rate of said flow through said pipe.

2. The system as recited in claim 1, wherein said ultrasonic receiver is configured for determining an average particle velocity within at least one flow measurement region defined by a proximal range limit and a distal range limit along a path of said ultrasonic beam.

3. The system as recited in claim 1, wherein said predetermined elevation angle is between 20 and 60 degrees with respect to horizontal.

4. The system as recited in claim 1, wherein said beam width angle is less than or equal to 20 degrees full width.

5. The system as recited in claim 1, wherein said plurality of wide band pulses have sufficient bandwidth to resolve particles separated by one centimeter.

6. The system as recited in claim 1, wherein said sequence of wide band pulses is sent at a pulse repetition rate sufficiently high to permit receiving signal returns from within the beam width angle for four consecutive pulses from a given same particle at a predetermined highest flow rate to be measured.

7. The system as recited in claim 1, wherein the transducer is configured for installation near the bottom of said pipe rotated from a bottom center to avoid silt at the bottom of the pipe, and a depth calculation based on an echo return delay from a particle is adjusted based on the actual installation position.

8. The system as recited in claim 1, wherein each pulse of said plurality of wide band pulses comprises an FM chirp pattern, and said receiver is configured to utilize a pattern matching correlation process that matches said FM chirp pattern to generate a pulse compression response signal corresponding to each said pulse of said plurality of wide band pulses.

9. The system as recited in claim 8, wherein said pulse compression response signal for each said pulse of said plurality of pulses is stored in an array having at least two dimensions, a first dimension relating to a response delay time and a second dimension relating to a pulse number; wherein said array is processed to identify at least one particle trajectory.

10. The system as recited in claim 9, wherein said ultrasonic receiver is configured to determine at least one trace corresponding to at least one particle trajectory of said plurality of particle trajectories, said trace comprising a contiguous region of said array containing cells having values above a predetermined threshold.

11. The system as recited in claim 10, wherein said ultrasonic receiver is configured to determine a path characteristic for said at least one trace.

12. The system as recited in claim 11, wherein said path characteristic is a slope or arc segment.

13. The system as recited in claim 12, further including a plurality of traces having a plurality of associated path characteristics; wherein said receiver is configured to sort said plurality of path characteristics into at least one depth bin and said receiver is configured to determine a mean path characteristic of said plurality of path characteristics and corresponding respective velocity for said at least one depth bin.

14. The system as recited in claim 13, wherein said receiver is configured to sort said plurality of path characteristics of said plurality of traces into a plurality of depth bins and said receiver is configured to determine a mean path characteristic and corresponding respective velocity for each depth bin of said plurality of depth bins.

15. The system as recited in claim 12, wherein the determination of said path characteristic includes comparing said at least one trace with a set of path characteristic hypotheses.

16. The system as recited in claim 10, wherein said ultrasonic receiver is configured to determine a slope spectrum for said at least one trace, said slope spectrum comprising a plurality of comparison values resulting from comparing said trace with a plurality of candidate slopes or arc segments.

17. The system as recited in claim 16, wherein said ultrasonic receiver is configured to determine a particle velocity based on a slope or arc segment associated with a maximum comparison value of said slope spectrum.

18. The system as recited in claim 16, wherein said receiver is configured to reject invalid trace responses based on said slope spectrum.

19. The system as recited in claim 10, wherein said receiver is configured to determine a depth for said trace, said depth based on a trace distance to a mid point on said trace at said predetermined elevation angle of said transducer.

20. The system as recited in claim 10, wherein said receiver is configured to determine a response distribution showing trace depth as a function of velocity for a plurality of traces, and to reject responses associated with a lower velocity peak of said distribution when said distribution is bimodal.

21. The system as recited in claim 2, wherein the flow measurement region is bounded by a distance along said beam including a reflection from a surface of the water and extending downward from the reflection to and not beyond a predetermined distance above the bottom of the pipe.

22. The system as recited in claim 2, wherein the beam is directed to reflect from a surface of the water to extend the flow measurement region below a blind range of the transducer and to avoid an exclusion zone above the bottom of the pipe.

23. The system as recited in claim 2, wherein the ultrasonic beam reflects from a surface of the water and the flow measurement region is bounded by an echo return delay corresponding to an echo range distance of not more than twice the distance from the transducer to the surface of the water along the ultrasonic beam.

24. The system as recited in claim 23, wherein the flow measurement region is further bounded by a predefined distance from the bottom of the pipe to exclude reflections from a flow region near the bottom of the pipe within a predefined exclusion distance.

25. A method for measuring a total flow rate of a flow in a partially filled pipe, comprising:
transmitting, by an ultrasonic transmitter, a transmitted ultrasonic signal;
said transmitted ultrasonic signal comprising a sequence of wide band pulses;
directing said transmitted ultrasonic signal upward at a predetermined inclined angle into said flow from a position at or near a bottom of said pipe, said transducer having a predetermined beam width angle;
receiving, by an ultrasonic receiver, reflected signals produced by said transmitted ultrasonic signal reflecting from objects in said flow;
processing, by said ultrasonic receiver, said reflected signals;
identifying a plurality of individual particle trajectories, each individual particle trajectory of said plurality of individual particle trajectories based on a plurality of wide band pulses of said sequence of wide band pulses;
processing, by said ultrasonic receiver, each said individual particle trajectory to determine a respective velocity and associated particle depth for each said individual particle trajectory;
generating a flow depth measurement;
combining said flow depth measurement and said pipe geometry information, with said individual particle trajectories and said associated particle depths to determine an average flow velocity relating to total flow rate of said flow through said pipe.
